(19) United States
(12) Patent Application Publication
(10) Pub. No.: US 2020/0104044 A1
(43) Pub. Date: Apr. 2, 2020

(54) ELECTRONIC EQUIPMENT, CONTROL DEVICE, AND CONTROL METHOD

(71) Applicant: SHARP KABUSHIKI KAISHA, Sakai City (JP)

(72) Inventors: SHUJI DAIOKU, Sakai City (JP); YASUAKI FUKUYAMA, Sakai City (JP)

(21) Appl. No.: 16/586,898

(22) Filed: Sep. 27, 2019

(30) Foreign Application Priority Data
Oct. 2, 2018 (JP) 2018-187621

(51) Int. Cl. G06F 3/0488; G06F 3/041; G06F 3/0484

(52) U.S. Cl. CPC G06F 3/04886; G06F 3/0484; G06F 3/0412

(57) ABSTRACT

A portable terminal device includes a display panel that has a notch formed in at least a part of a marginal region, a touch panel that is superimposed on the display panel, and a display control unit. The display control unit executes display processing that displays a screen in a screen display region excluding operation regions located on two sides of the notch in the display panel and emergence processing that causes an operation screen that accepts an operation on the portable terminal device to emerge when a slide operation on the touch panel from the operation region toward the screen display region is sensed.

### BACKGROUND

### 1. Field

The present disclosure relates to electronic equipment including a display unit and a touch panel.

### 2. Description of the Related Art

Electronic equipment, such as a smartphone, for which touch panel-based input is the mainstream, does not include hardware keys, unlike a conventional mobile phone handset. For this reason, a navigation bar for an operation, such as restoring each of a plurality of application programs to its state before an operation, moving to a home screen, or switching between tasks, is displayed in the electronic equipment.

For example, Japanese Unexamined Patent Application Publication (Translation of PCT Application) No. 2015-505084 (laid open on Feb. 16, 2015) discloses provision of a navigation bar for switching between modules within an expanded communication service, such as email, calendar, contacts, and tasks, and for presenting preview peeks associated with each module to a user.

However, a navigation bar is generally displayed on a region for displaying an application program screen. This reduces a display area for the region and causes the problem of inability to display the application program screen in the foreground.

It is desirable to secure a wide display area for a screen of an application program or the like.

### SUMMARY

In order to fix the above-described problem, according to an aspect of the present disclosure, there is provided electronic equipment including a display unit that has a notch formed in at least a part of a marginal region, a touch panel that is superimposed on the display unit, and a control unit. The control unit executes: display processing that displays a screen in a screen display region excluding side regions located on two sides of the notch in the display unit; and emergence processing that causes an operation screen that accepts an operation on the electronic equipment to emerge when a slide operation on the touch panel from the side region toward the screen display region is sensed.

### Advantageous Effects of Invention

An aspect of the disclosure advantageously secures a wide display area for a screen of an application program or the like.

### BRIEF DESCRIPTION OF THE DRAWINGS

FIG. 1 is a block diagram illustrating a hardware configuration of each of portable terminal devices according to first to third embodiments of the present disclosure;

FIG. 2 is a plan view illustrating an appearance configuration of the portable terminal device;

FIG. 3 is a plan view illustrating a configuration of a display panel in the portable terminal device;

FIG. 4 is a block diagram illustrating a system configuration of the portable terminal device;

FIG. 5A is a partial enlarged view illustrating a state where an operation is performed from a screen non-display region in each of the portable terminal devices according to the first and second embodiments of the present disclosure;

FIG. 5B is a partial enlarged view illustrating a state where an operation screen is displayed in a screen display region in the portable terminal device;

FIG. 6A is a partial enlarged view illustrating a state where an operation is performed from the screen non-display region in the portable terminal device according to the second embodiment of the present disclosure;

FIG. 6B is a partial enlarged view illustrating a state where an operation screen is displayed in the screen display region in the portable terminal device; and

FIG. 7 is a partial enlarged view illustrating a configuration of a touch sensor and its surroundings in the portable terminal device according to the third embodiment of the present disclosure.

### DESCRIPTION OF THE EMBODIMENTS

### First Embodiment

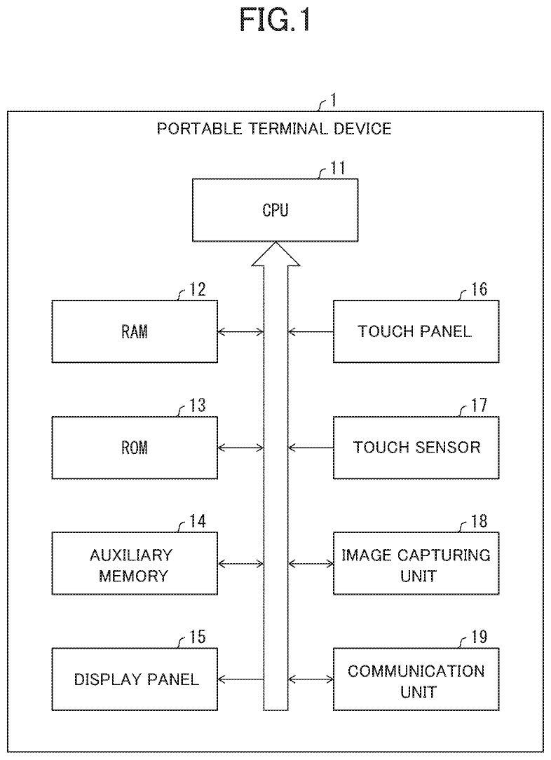

A first embodiment of the present disclosure will be described as follows with reference to FIGS. 1 to 5B.

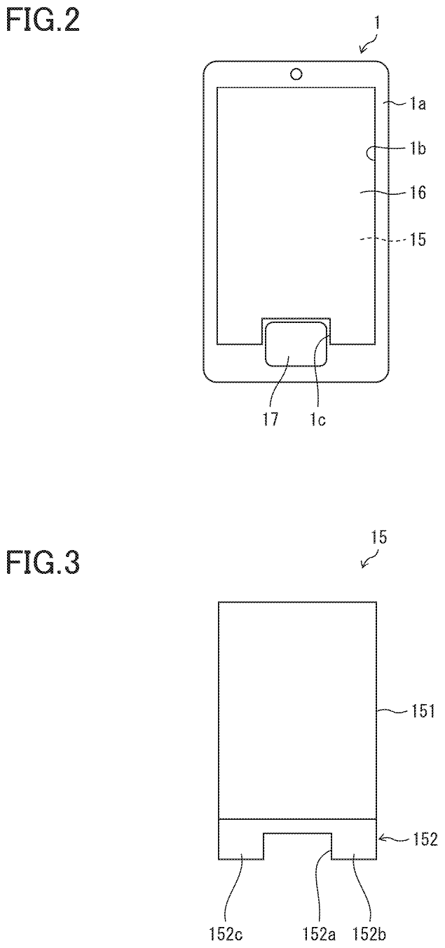

FIG. 1 is a block diagram illustrating a hardware configuration of each of portable terminal devices 1 according to first to third embodiments of the present disclosure. FIG. 2 is a plan view illustrating an appearance configuration of the portable terminal device 1. FIG. 3 is a plan view illustrating a configuration of a display panel 15 in the portable terminal device 1.

The portable terminal device 1 (electronic equipment) is a communication terminal device, in which a dedicated operating system (OS) is implemented, and has an environment for execution of an application program, as described below. Examples of the portable terminal device 1 include a smartphone, a tablet terminal, and the like.

As illustrated in FIG. 1, the portable terminal device 1 includes a central processing unit (CPU) 11, a random access memory (RAM) 12, a read only memory (ROM) 13, an auxiliary memory 14, a display panel 15 (display unit), a touch panel 16, a touch sensor 17 (contact sensor), an image capturing unit 18, and a communication unit 19.

The CPU 11 is a processing device which executes a system program for the portable terminal device 1. More specifically, the CPU 11 receives data from the RAM 12, the auxiliary memory 14, the touch panel 16, the touch sensor 17, or the like at the time of execution of the system program and outputs a result of subjecting the data to computation or processing to the RAM 12, the auxiliary memory 14, the display panel 15, or the like.

The RAM 12 is a memory which constitutes a main storage in the portable terminal device 1 and is composed of a dynamic random access memory (DRAM) or the like.

The ROM 13 stores a program, such as a basic input output system (BIOS) executed at the time of activation or resetting of the portable terminal device 1, which is indispensable for the action of the portable terminal device 1, in addition to the system program.

The auxiliary memory 14 is provided to store a program, data, and the like desired for the action of the portable terminal device 1. The auxiliary memory 14 is composed of, for example, a flash memory.

The display panel 15 is provided to display a screen for implementing basic operations of the portable terminal device 1, a screen which is displayed as a result of execution of an application program, and the like. A flat plate display panel, such as a liquid crystal display panel or an electro-luminescence (EL) display panel, is used as the display panel 15.

The touch panel 16 is arranged on the display panel 15, and accepts a touch operation on a screen displayed on the display panel 15 and outputs a touch operation signal as an input signal.

The touch sensor 17 is a sensor which senses a contact (a contact action and a contact target) of an indicator, such as a finger. Examples of the touch sensor 17 include a fingerprint sensor and a pressure-sensitive sensor.

The image capturing unit 18 includes a hardware portion, such as a camera, and a software portion which controls image capturing by the camera, for performing image capturing.

The communication unit 19 is a portion which includes a communication circuit for communication via an Internet 5.

As illustrated in FIG. 2, the portable terminal device 1 includes a housing 1a forming a substantially rectangular shape. An opening 1b is provided at the front of the housing 1a. In the opening 1b, the display panel 15 and the touch panel 16 are exposed. The opening 1b forms a substantially rectangular shape, and a notch 1c is formed roughly in the center of a marginal region on one short side. A plurality of notches 1c may be formed in the marginal region, where the notch 1c is to be provided, or one or more notches 1c may be formed in three other marginal regions in the opening 1b.

The touch sensor 17 is arranged such that a part thereof is located in the notch 1c and such that the remainder is located outside the notch 1c.

As illustrated in FIG. 3, an effective display region of the display panel 15 is formed to have the same shape and the same size as the opening 1b. Additionally, the display panel 15 is divided into a screen display region 151 and a screen non-display region 152.

The screen display region 151 is a region where various screens including prescribed screens as described above, such as a home screen and a setup screen, in addition to an application screen generated as a result of executing an application program are to be displayed. The screen display region 151 accounts for the greater part of the effective display region of the display panel 15, excluding an end portion on a side with the notch 1c.

The screen non-display region 152 is a region which does not contribute to display of an image including a screen. The screen non-display region 152 has a notch 152a and operation regions 152b and 152c (side regions).

The notch 152a is formed at the same position as the notch 1c of the opening 1b to have the same shape and the same size as the notch 1c. A plurality of notches 152a may be formed in the marginal region, where the notch 152a is to be provided, or one or more notches 152a may be formed in the three other marginal regions in the display panel 15 so as to correspond to the notches 1c. If the notches 152a are formed in the three other marginal regions in the display panel 15, the screen non-display region 152 needs to be provided in each of the marginal regions. A configuration as illustrated in FIG. 3 where the notch 152a is provided only at one location will be illustrated in the following description.

The operation regions 152b and 152c are formed on two sides of the notch 1c. The operation regions 152b and 152c are regions which allow only an operation on the touch panel 16 for displaying an operation screen 200 (to be described later).

The touch panel 16 is formed to have the same shape and the same size as the display panel 15. The touch panel 16 is arranged so as to be superimposed on the display panel 15.

Note that the display panel 15 and the touch panel 16 each have a region (outer peripheral end portion) of the housing 1a which is hidden under a frame-like portion formed along a margin of the opening 1b. The region includes a site at which a connection terminal and the like are formed. The hidden region is not illustrated in FIG. 3 for the sake of convenience.

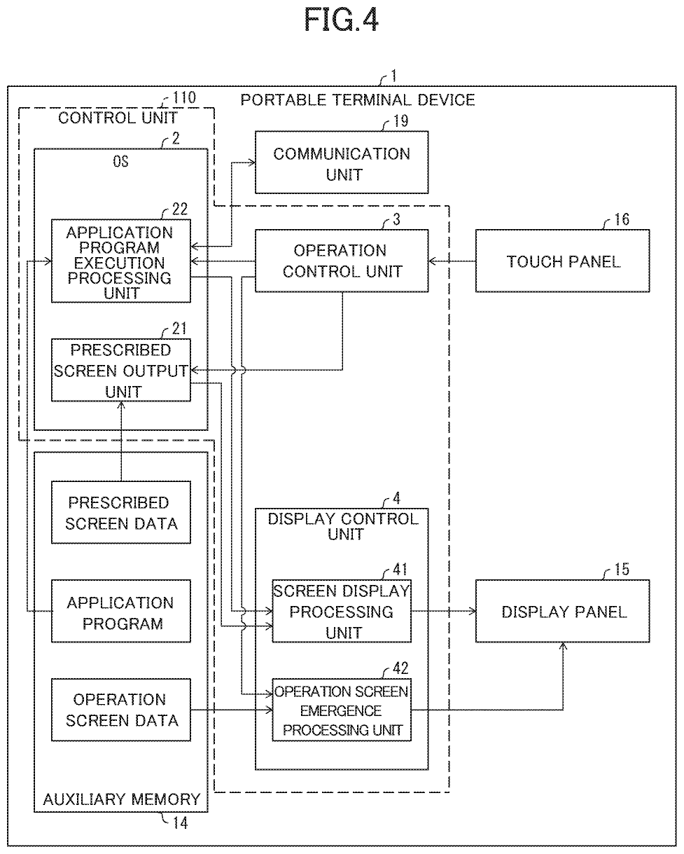

A system configuration of the portable terminal device 1 will be described. FIG. 4 is a block diagram illustrating the system configuration.

As illustrated in FIG. 4, the portable terminal device 1 includes a control unit 110. The control unit 110 is the CPU 11 and functions as a control device which oversees and controls units of the portable terminal device 1. The control unit 110 includes an operating system (hereinafter referred to as an “OS”) 2, an operation control unit 3, and a display control unit 4.

The OS 2 is a basic program which provides basic functions, such as management of the RAM 12, the ROM 13, the auxiliary memory 14, the touch panel 16, the touch sensor 17, the image capturing unit 18, and the communication unit 19 described above, which are to be commonly utilized by application programs and manages the whole of a system of the portable terminal device 1. The OS 2 includes a prescribed screen output unit 21 and an application program execution processing unit 22.

The auxiliary memory 14 here stores pieces of data for various prescribed screens (pieces of prescribed screen data), pieces of operation screen data, and various application programs. The pieces of prescribed screen data are pieces of data for prescribed screens which are desired for basic actions of the portable terminal device 1 and are prepared in advance, such as the home screen and the setup screen. The pieces of operation screen data are pieces of data for displaying operation screens for various operations.

The prescribed screen output unit 21 reads out prescribed screen data stored in the auxiliary memory 14 for a prescribed screen designated by the operation control unit 3 and outputs the prescribed screen data to the display control unit 4.

The application program execution processing unit 22 activates and executes an application program, an instruction for activation of which is given, among a plurality of application programs stored (saved) in the auxiliary memory 14. The application program execution processing unit 22 also ends an application program, an instruction for ending of which is given, among application programs being executed. An application program generates data for an application window (application screen) upon execution and outputs the data to the display control unit 4.

The operation control unit 3 tells details of control, such as switching of a screen to be displayed on the display panel 15 or a screen operation (for example, scrolling, pinch-in, or pinch-out), to the OS 2 in accordance with an operation on the touch panel 16.

The display control unit 4 performs control that displays a screen on the display panel 15. The display control unit 4 includes a screen display processing unit 41 (display processing unit) and an operation screen emergence processing unit 42 (emergence processing unit) to implement the function.

The screen display processing unit 41 performs display processing that displays a screen in the screen display region 151 of the display panel 15 on the basis of screen data output from the OS 2.

The operation screen emergence processing unit 42 performs emergence processing that causes an operation screen to emerge in the screen display region 151 of the display panel 15 on the basis of operation screen data stored in the auxiliary memory 14.

The action of the portable terminal device 1 configured in the above-described manner will be described.

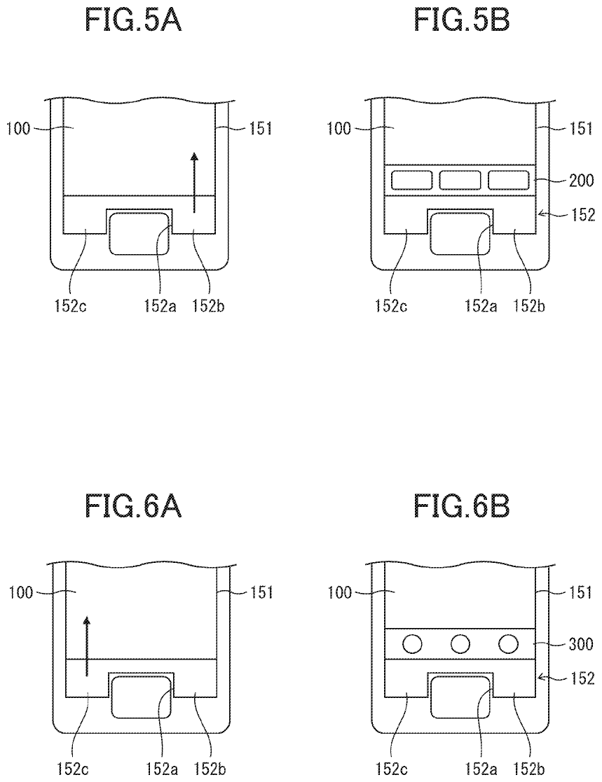

FIG. 5A is a partial enlarged view illustrating a state where an operation is performed from the screen non-display region 152 in the portable terminal device 1. FIG. 5B is a partial enlarged view illustrating a state where the operation screen 200 is displayed in the screen display region 151 in the portable terminal device 1.

As illustrated in FIG. 5A, a swipe operation (slide operation) is performed in an arrow direction from the operation region 152b toward the screen display region 151 while a screen 100 is displayed in the screen display region 151 (a display processing process). The operation is output as touch data from the touch panel 16 to the operation control unit 3. When the operation control unit 3 recognizes the swipe operation on the basis of the touch data, the operation control unit 3 instructs the operation screen emergence processing unit 42 to cause an operation screen to emerge.

Upon receipt of the instruction from the operation control unit 3, the operation screen emergence processing unit 42 reads out operation screen data from the auxiliary memory 14. The operation screen emergence processing unit 42 then outputs the operation screen data to the display panel 15 and displays the operation screen in the screen display region 151 of the display panel 15. As illustrated in FIG. 5B, the operation screen emergence processing unit 42 causes the operation screen 200 to emerge (displays the operation screen 200) such that the operation screen 200 lies on top of the screen 100 (an emergence processing process) while the screen 100 is displayed in the screen display region 151.

With the above-described process, the operation screen 200 is displayed to have a prescribed width from a boundary between the screen display region 151 and the screen non-display region 152 in the screen display region 151, as illustrated in FIG. 5B. The operation screen 200 is, for example, a navigation bar. The navigation bar includes, for example, keys for operation of the portable terminal device 1, such as a return key for returning from a currently displayed screen to a previously displayed screen, a home key for switching display to the home screen, and a task key for selecting a task.

When an operation of touching a key is performed on the operation screen 200, the operation is output as touch data from the touch panel 16 to the operation control unit 3. When the operation control unit 3 recognizes the key operation on the operation screen 200 on the basis of the touch data, the operation control unit 3 instructs the OS 2 to perform processing corresponding to the key operation.

The OS 2 performs processing, such as outputting data for an application screen or a prescribed screen to the display control unit 4 or executing a designated task, to switch the display in accordance with the above-described instruction.

If an operation on the operation screen 200 is not performed for a fixed time period, the operation screen emergence processing unit 42 controls the display panel 15 to stop display of the operation screen 200.

Note that, if a swipe operation is performed in the arrow direction from the operation region 152c toward the screen display region 151, the same display processing for the operation screen 200 as described above is performed.

As described above, the portable terminal device 1 according to the present embodiment includes the operation screen emergence processing unit 42 that causes the operation screen 200 accepting an operation on the portable terminal device 1 to emerge when the operation screen emergence processing unit 42 senses a slide operation on the touch panel 16 from the operation region 152b or 152c toward the screen display region 151.

With the above-described configuration, if a user performs a swipe operation from the operation region 152b or 152c toward the screen display region 151 when the user desires, the operation screen 200 can be made to emerge. Additionally, the operation screen 200 can be kept from emerging when there is no need for the operation screen 200. It is thus possible to utilize the screen display region 151 with a largest area when the operation screen 200 is not used.

The operation screen 200 may be made to emerge so as to lie on top of the screen 100. This obviates the need to reduce a display area for the screen 100 for each occasion of emergence of the operation screen 200 in order to secure space for emergence of the operation screen 200. It is thus possible to simplify the display processing by the display control unit 4.

### Second Embodiment

A second embodiment of the present disclosure will be described as follows with reference to FIGS. 4 to 6B. Note that components having functions equivalent to those of the components according to the first embodiment in the present embodiment are denoted by same reference characters and that a description thereof will be omitted.

FIG. 6A is a partial enlarged view illustrating a state where an operation is performed from a screen non-display region 152 in a portable terminal device 1 according to the present embodiment. FIG. 6B is a partial enlarged view illustrating a state where an operation screen 300 is displayed in a screen display region 151 in the portable terminal device 1.

As illustrated in FIG. 4, in the portable terminal device 1 according to the present embodiment, an operation screen emergence processing unit 42 of a display control unit 4 performs operation screen display control different from that by the operation screen emergence processing unit 42 according to the first embodiment. More specifically, the operation screen emergence processing unit 42 controls a display panel 15 to display one of operation screens having different operation functions when a swipe operation is performed from one operation region 152b to a screen display region 151 and the other when a swipe operation is performed from the other operation region 152c to the screen display region 151.

For example, as illustrated in FIG. 5A, a swipe operation is performed in an arrow direction from the operation region 152b toward the screen display region 151 while a screen 100 is displayed in the screen display region 151. In this case, the operation screen emergence processing unit 42 receives an instruction from an operation control unit 3, outputs operation screen data read out from an auxiliary memory 14 to the display panel 15, and displays an operation screen 200 illustrated in FIG. 5B in the screen display region 151 of the display panel 15, as described above.

As illustrated in FIG. 6A, a swipe operation is performed in the arrow direction from the operation region 152c toward the screen display region 151 while the screen 100 is displayed in the screen display region 151. In this case, the operation screen emergence processing unit 42 receives an instruction from the operation control unit 3, outputs operation screen data read out from the auxiliary memory 14 to the display panel 15, and causes the operation screen 300 to emerge (displays the operation screen 300) illustrated in FIG. 6B in the screen display region 151 of the display panel 15.

With the above-described configuration, the operation screen emergence processing unit 42 displays the operation screen 300 such that the operation screen 300 lies on top of a screen while the screen is displayed in the screen display region 151, as illustrated in FIG. 6B. The operation screen 300 is, for example, an icon bar. The icon bar includes, for example, a plurality of icons (shortcut icons) for application program activation.

As described above, in the portable terminal device 1 according to the present embodiment, the operation screen emergence processing unit 42 displays one (or the other) of operation screens having different operation functions singly (only either one) on the display panel 15 in accordance with a swipe operation from the operation region 152b (or 152c).

The two operation screens 200 and 300 different in operation function can be assigned to the two operation regions 152b and 152c present for one notch 152a, as described above. For this reason, while the screen 100 is displayed in the screen display region 151, it is possible to cause the operation screen 200 as a navigation bar to emerge and operate a key and to cause the operation screen 300 as an icon bar to emerge and operate a shortcut icon without switching display to a home screen. Thus, the operability of the portable terminal device 1 can be further improved.

Note that the above-described example displays a navigation bar by a swipe operation from the operation region 152b and displays an icon bar by a swipe operation from the operation region 152c. The present disclosure, however, is not limited to this. An icon bar may be displayed by a swipe operation from the operation region 152b, and a navigation bar may be displayed by a swipe operation from the operation region 152c. The operation screen 200 is not limited to a navigation bar and may be an operation screen having any other operation functions. Similarly, the operation screen 300 is not limited to an icon bar and may be an operation screen having any other operation functions.

### Third Embodiment

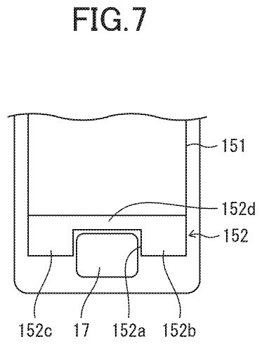

A third embodiment of the present disclosure will be described as follows with reference to FIGS. 4 and 7. Note that components having functions equivalent to those of the components according to the first embodiment in the present embodiment are denoted by same reference characters and that a description thereof will be omitted.

FIG. 7 is a partial enlarged view illustrating a configuration of a touch sensor and its surroundings in a portable terminal device 1 according to the present embodiment.

As illustrated in FIG. 7, a dead region 152d is provided in a screen non-display region 152. The dead region 152d is a region, in a screen non-display region 152, which is surrounded by a notch 152a, operation regions 152b and 152c, and a screen display region 151. The dead region 152d is configured not to accept an operation on a touch panel 16.

More specifically, an operation control unit 3 illustrated in FIG. 4 disables a touch operation on the dead region 152d on the basis of touch data output from the touch panel 16 upon the touch operation on the dead region 152d. For this reason, if the operation control unit 3 recognizes that a touch operation on the dead region 152d is performed, the operation control unit 3 does not tell the touch operation to an OS 2.

Note that a method for disabling a touch operation on the dead region 152d is not limited to the above-described example.

As described above, the portable terminal device 1 according to the present embodiment has the dead region 152d in the screen non-display region 152.

If the screen display region 151 is provided close to the notch 152a to be increased in size, the touch panel 16 may respond to an accidental contact with the screen display region 151 at the time of an operation on the touch sensor 17 arranged in the notch 152a and may cause an erroneous operation. In contrast, in the above-described configuration, the dead region 152d can inhibit the touch panel 16 from responding to an accidental contact with the screen display region 151 at the time of an operation on the touch sensor 17.

### [Examples of Implementation by Software]

A control block (the control unit 110 in particular) of the portable terminal device 1 may be implemented by a logic circuit (hardware) formed at an integrated circuit (IC chip) or the like or may be implemented by software.

In the latter case, the portable terminal device 1 includes a computer which executes instructions of a control program as software which implements functions (a control method). For example, the computer includes at least one processor (control device) and also includes at least one computer-readable recording medium having the control program stored therein. The processor reads the program from the recording medium and executes the program in the computer, thereby achieving a goal of the present disclosure.

For example, the CPU 11 can be used as the above-described processor. A non-transitory tangible medium, such as the ROM 13, a tape, a disk, a card, a semiconductor memory, or a programmable logic circuit, can be used as the above-described recording medium. The above-described control program may be loaded into the RAM 12.

The above-described control program may be supplied to the above-described computer via an arbitrary transmission medium (a communication network, airwaves, or the like) which can transmit the control program. Note that an aspect of the present disclosure can be implemented in the form of a data signal embedded in a carrier wave obtained when the program is embodied through electronic transmission.

### CONCLUSION

Electronic equipment according to a first aspect of the present disclosure includes a display unit (the display panel 15) that has the notch 152a formed in at least a part of a marginal region, the touch panel 16 that is superimposed on the display unit, and a control unit (the display control unit 4). The control unit executes: display processing that displays a screen in the screen display region 151 excluding side regions located on two sides of the notch 152a in the display unit; and emergence processing that causes an operation screen that accepts an operation on the electronic equipment to emerge when a slide operation on the touch panel 16 from the side region (the operation region 152b or 152c) toward the screen display region 151 is sensed.

With the above-described configuration, it is possible to cause the operation screen to emerge when there is a need and keep the operation screen from emerging when there is no need. This allows utilization of the screen display region with a largest area when the operation screen is not used.

According to a second aspect of the present disclosure, in the electronic equipment of the first aspect, the control unit may cause the operation screen to emerge to lie on top of the screen displayed in the screen display region 151 in the emergence processing.

With the above configuration, there is no need to reduce a display area for the screen for each occasion of emergence of the operation screen in order to secure space for emergence of the operation screen. This allows simplification of the display processing by the control unit.

According to a third aspect of the present disclosure, in the electronic equipment of the first or second aspect, the operation screen may include operation screens having respective different operation functions, and the control unit may cause one of the operation screens to emerge when a slide operation is performed toward one of the side regions and may cause the other of the operation screens to emerge when a slide operation is performed toward the other of the side regions, in the emergence processing.

With the above configuration, the two operation screens different in operation function can be assigned to the two side regions present for the one notch. For example, a navigation bar can be provided on one of the operation screens, and a shortcut icon for an application program or the like which is generally displayed on a home screen can be provided on the other operation screen. This makes it possible to cause the operation screen to emerge while the screen is displayed in the screen display region and operate the navigation bar and to operate the shortcut icon without switching display to the home screen. Thus, the operability of the electronic equipment can be further improved.

According to a fourth aspect of the present disclosure, the electronic equipment of any one of the first to third aspects may further include a contact sensor (the touch sensor 17) that is arranged in the notch 152a. The dead region 152d that does not accept an operation on the touch panel 16 may be provided between the notch 152a and the screen display region 151 in the display unit.

If the screen display region is provided close to the notch for increase in screen size, the touch panel may respond to an accidental contact with the screen display region at the time of an operation on the contact sensor arranged in the notch and cause an erroneous operation. In contrast, in the above-described configuration, the dead region can inhibit the touch panel from responding to the accidental contact with the screen display region at the time of an operation on the contact sensor.

A control device according to a fifth aspect of the present disclosure is a control device for controlling electronic equipment (the portable terminal device 1) including a display unit (the display panel 15) that has a notch formed in at least a part of a marginal region and the touch panel 16 that is superimposed on the display unit. The control device includes: a display processing unit that displays a screen in a screen display region excluding side regions located on two sides of the notch in the display unit; and an emergence processing unit that causes an operation screen that accepts an operation on the electronic equipment to emerge when a slide operation on the touch panel 16 from the side region toward the screen display region is sensed.

With the above-described configuration, it is possible to utilize the screen display region with a largest area when the operation screen is not used, as in the electronic equipment according to the first aspect.

A control method according to a sixth aspect of the present disclosure is a control method for controlling electronic equipment (the portable terminal device 1) including a display unit (the display panel 15) that has a notch formed in at least a part of a marginal region and the touch panel 16 that is superimposed on the display unit. The control method includes: displaying a screen in the screen display region 151 excluding side regions (152b and 152c) located on two sides of the notch in the display unit; and causing an operation screen that accepts an operation on the electronic equipment to emerge when a slide operation on the touch panel 16 from the side region toward the screen display region 151 is sensed.

With the above-described configuration, it is possible to utilize the screen display region with a largest area when the operation screen is not used, as in the electronic equipment according to the first aspect.

The electronic equipment according to each aspect of the present disclosure may be implemented by a computer. In this case, an electronic equipment control program which implements the electronic equipment by the computer by causing the computer to act as the units (software elements) of the electronic equipment and a computer-readable recording medium having the control program recorded thereon also fall within the scope of the present disclosure.

### ADDITIONAL MATTER

The present disclosure is not limited to the above-described embodiments, and various changes can be made within the scope described in the claims. An embodiment obtained by appropriately combining technical measures disclosed in. different embodiments is also included in the technical scope of the present disclosure. Additionally, combination of the technical measures disclosed in the embodiments allows formation of a new technical feature.

The present disclosure contains subject matter related to that disclosed in Japanese Priority Patent Application JP 2018-187621 filed in the Japan Patent Office on Oct. 2, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. Electronic equipment comprising:
a display unit that has a notch formed in at least a part of a marginal region;
a touch panel that is superimposed on the display unit; and
a control unit, wherein
the control unit executes
display processing that displays a screen in a screen display region excluding side regions located on two sides of the notch in the display unit and
emergence processing that causes an operation screen that accepts an operation on the electronic equipment to emerge when a slide operation on the touch panel from the side region toward the screen display region is sensed.

2. The electronic equipment according to claim 1, wherein the control unit causes the operation screen to emerge to lie on top of the screen displayed in the screen display region in the emergence processing.

3. The electronic equipment according to claim 1, wherein the operation screen includes operation screens having respective different operation functions, and the control unit causes one of the operation screens to emerge when a slide operation is performed toward one of the side regions and causes the other of the operation screens to emerge when a slide operation is performed toward the other of the side regions, in the emergence processing.

4. The electronic equipment according to claim 1, further comprising:
a contact sensor that is arranged in the notch, wherein
a dead region that does not accept an operation on the touch panel is provided between the notch and the screen display region in the display unit.

5. A control device for controlling electronic equipment including a display unit that has a notch formed in at least a part of a marginal region and a touch panel that is superimposed on the display unit, the control device comprising:
a display processing unit that displays a screen in a screen display region excluding side regions located on two sides of the notch in the display unit; and
an emergence processing unit that causes an operation screen that accepts an operation on the electronic equipment to emerge when a slide operation on the touch panel from the side region toward the screen display region is sensed.

6. A control method for controlling electronic equipment including a display unit that has a notch formed in at least a part of a marginal region and a touch panel that is superimposed on the display unit, the control method comprising:
displaying a screen in a screen display region excluding side regions located on two sides of the notch in the display unit; and
causing an operation screen that accepts an operation on the electronic equipment to emerge when a slide operation on the touch panel from the side region toward the screen display region is sensed.
